(19) United States
(12) Patent Application Publication
(10) Pub. No.: US 2025/0297039 A1
(43) Pub. Date: Sep. 25, 2025

(54) OLEFIN POLYMERIZATION CATALYST COMPONENTS CONTAINING DIGLYCIDYLESTER COMPONENTS AND ITS USE FOR THE PRODUCTION OF POLYPROPYLENE HAVING HIGH ISOTACTICITY AT HIGH MELT FLOW RATE

(71) Applicant: Formosa Plastics Corporation, U.S.A., Livingston, NJ (US)

(72) Inventors: Gapgoung KONG, Sugarland, TX (US); Cyrus C. Y. LEE, Victoria, TX (US); Chih-Jian CHEN, Port Lavaca, TX (US)

(21) Appl. No.: 18/609,678

(22) Filed: Mar. 19, 2024

(51) Int. Cl. C08F 4/54; C08F 2/02; C08F 4/52; C08F 4/72; C08F 110/06

(52) U.S. Cl. CPC C08F 4/54; C08F 2/02; C08F 4/52; C08F 4/72; C08F 110/06

(57) ABSTRACT

The present invention relates to a phthalate free Ziegler-Natta catalyst component for olefin polymerization, prepared in the presence of a diglycidylester compound in combination with one or more internal electron donors. The catalyst components, according to present invention, produce polypropylene polymers having higher stereo-regularity with high melt flow rate than polymers produced with catalyst components not including a diglycidylester compound.

### BACKGROUND

The present invention relates to (1) phthalate free Ziegler-Natta catalyst components for olefin polymerization prepared in the presence of diglycidylester compounds as one of internal donors in conjunction with one or more internal donors comprising urea, malonate and 1,3-diether; and (2) to methods of making such polymerization catalyst systems, which can produce phthalate free polypropylene having high isotacticity and high melt flow rate.

Ziegler-Natta catalyst systems for polyolefin polymerization are well known in the art. Commonly, these systems are composed of a solid Ziegler-Natta catalyst component and a co-catalyst component, usually an organoaluminum compound, and/or an external electron donor to be used in conjunction. The Ziegler-Natta catalyst components have included magnesium, halide, titanium and internal electron donor compounds which have been widely employed to increase the activity and stero-specificity of polymerization catalyst system.

Common internal electron donor compounds, which are incorporated in the solid Ziegler-Natta catalyst component during preparation of such component, are known in the art and include ethers, ketones, amines, alcohols, heterocyclic organic compounds, phenols, phosphines, and silanes. It is well known in the art that polymerization activity, as well as stereoregularity, molecular weight, and molecular weight distribution of the resulting polymer, depend on the molecular structure of the internal electron donor employed. Therefore, in order to improve the polymerization process and the properties of the resulting polymer, there has been an effort and desire to develop various internal electron donors. Examples of such internal electron donor compounds and their use as a component of the catalyst system are described in U.S. Pat. Nos. 4,107,414; 4,186,107; 4,226,963; 4,347,160; 4,382,019; 4,435,550; 4,465,782; 4,522,930; 4,530,912; 4,532,313; 4,560,671; 4,657,882; 5,208,302; 5,902,765; 5,948,872; 6,048,818; 6,121,483; 6,281,301; 6,294,497; 6,313,238; 6,395,670; 6,436,864; 6,605,562; 6,716,939; 6,770,586; 6,818,583; 6,825,309; 7,022,640; 7,049,377; 7,202,314; 7,208,435; 7,223,712; 7,351,778; 7,371,802; 7,491,781; 7,544,748; 7,674,741; 7,674,943; 7,888,437; 7,888,438; 7,935,766; 7,964,678; 8,003,558; 8,003,559; 8,088,872; 8,211,819; 8,222,357; 8,227,370; 8,236,908; 8,247,341; 8,263,520; 8,263,692; 8,288,304; 8,288,585; 8,288,606; 8,318,626; 8,383,540; 8,536,290; 8,569,195; 8,575,283; 8,604,146; 8,633,126; 8,692,927; 8,664,142; 8,680,222; 8,716,514; and 8,742,040, which are each incorporated by reference in its entirety herein.

In the utilization of Ziegler-Natta type catalysts for polymerizations involving propylene or other olefins for which isotacticity is a possibility, it may be desirable to utilize an external electron donor, and acceptable external electron donors include organic compounds containing O, Si, N, S, and/or P. Such compounds include organic acids, organic acid esters, organic acid anhydrides, ethers, ketones, alcohols, aldehydes, silanes, amides, urea, amines, amine oxides, thiols, various phosphorus acid esters and amides, etc. Preferred external electron donors are organosilicon compounds containing Si—O—C and/or Si—N—C bonds, having silicon as the central atom. Such compounds are described in U.S. Pat. Nos. 4,472,524; 4,473,660; 4,560,671; 4,581,342; 4,657,882; 5,106,807; 5,407,883; 5,684,173; 6,228,961; 6,362,124; 6,552,136; 6,689,849; 7,009,015; 7,244,794; 7,276,463; 7,619,049; 7,790,819; 8,247,504; 8,648,001; and 8,614,162, which are each incorporated by reference in its entirety herein.

Meanwhile, there has been demand for polypropylene material having high isotacticity for stiffness and high melt flow rate. U.S. Pat. No. 7,465,776 introduced a catalyst component containing phthalate and diether internal donor producing polypropylene having high isotacticity and high melt flow rate. Most commercial propylene polymerization catalysts currently used employ alkyl phthalate esters as an internal electron donor. But still there is a need to further improve stereo-regularity of catalyst components employing alkyl phthalate esters as an internal donor for the application of polypropylene polymer to impact copolymers. Moreover, certain environmental issues have been recently raised concerning the continued use of phthalate derivatives in human contact applications.

U.S. Pat. No. 7,491,781 teaches the use of an internal electron donor in a propylene polymerization catalyst component which does not contain a phthalate derivative. However the resultant propylene polymerization catalyst produced polypropylene with lower isotacticity than that of a catalyst containing a phthalate derivative. Recently, U.S. Pat. No. 9,593,184 teaches the use of oxalic acid amide compound as a modifier in the composition of solid catalyst components to improve stereo-regularity that enables the production of a phthalate-free catalyst system with stereo-regularity that is equal to or better than phthalate catalyst systems.

As such, there is still a need to develop a phthalate free catalyst system that can produce polypropylene having high melt flow rate with high isotacticity.

### SUMMARY OF THE INVENTION

It is therefore an object of present invention to provide a method of preparing a phthalate free Ziegler-Natta catalyst components producing polypropylene having high melt flow rate with high isotacticity, where the catalyst components comprises magnesium, titanium, halide, a diglycidylester compound selected from the compound represented by Formula I, and one or more internal electron donors comprising urea, malonate and 1,3-diether.

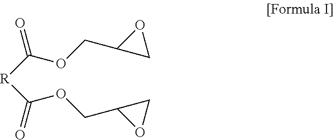

wherein R is a hydrocarbon having 1 to 20 carbon atoms, which may also include an aliphatic or aromatic cyclic ring.

### DESCRIPTION OF PREFERRED EMBODIMENTS

In accordance with the present invention, diglycidylester compound employed as an element of solid phthalate free Ziegler-Natta catalyst components in conjunction with one or more internal donors comprising urea, malonate and 1,3-diether, for the production of polyolefins, particularly polypropylene having high isotacticity and high melt flow rate.

According to certain aspects of the present invention, the diglycidylester compounds that may be employed as an element of solid catalyst composition are represented by Formula I:

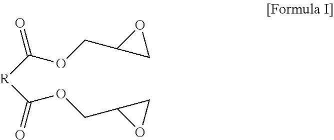

wherein R is a hydrocarbon having 1 to 20 carbon atoms, which may also include an aliphatic or aromatic cyclic ring.

Typical, and acceptable, Ziegler-Natta type catalyst systems that may be used in accordance with the present invention comprise (a) a solid Ziegler-Natta type catalyst component prepared in the presence of diglycidylester compound with one or more internal donors comprising urea, malonate and 1,3-diethers; (b) a co-catalyst component, and optionally (c) one or more external electron donors.

Preferred examples of diglycidylester compounds of Formula I include, but are not limited to: diglycidylphthalate; diglycidyl-1,2-cyclohexanedicarboxylate; diglycidyl-1,2-cyclopentanedicarboxylate; diglycidyl-1,2-cyclobutanedicarboxylate; diglycidyl-2,3-isopropylsuccinate; diglycidylsuccinate; diglycidylmalonate; diglycidylglutarate; bis(2,3-epoxypropyl) adipate; or their derivatives.

Preferred examples of urea internal donor compounds that may be employed as an element of solid catalyst composition include, but are not limited to N,N,N′,N′-tetramethylurea; N,N,N′,N′-tetraethylurea; N,N,N′,N′-tetrapropylurea; N,N,N′,N′-tetrabutylurea; N,N,N′,N′-tetrapentylurea; N,N,N′,N′-tetrahexylurea; N,N,N′,N′-tetra(cyclopropyl)urea; N,N,N′,N′-tetra(cyclohexyl)urea; N,N,N′,N′-tetraphenylurea; bis(butylene)urea; bis(pentylene)urea; N,N′-dimethylethyleneurea; N,N′-dimethylpropyleneurea; N,N′-dimethyl(2-(methylaza)propylene)urea; N,N′-dimethyl(3-(methylaza)pentylene)urea; n-amyltriphenylurea; n-hexyltriphenylurea; n-octyltriphenylurea; n-decyltriphenylurea; n-octadecyltriphenylurea; n-butyltritolylurea; n-butyltrinaphthylurea; n-hexyltrimethylurea; n-hexyltriethylurea; noctyltrimethylurea; dihexyldimethylurea; dihexyldiethylurea; trihexylmethylurea; tetrahexylurea: n-butyltricyclohexylurea; t-butyltriphenylurea; 1,1-bis(p-biphenyl)-3-methyl-3-n-octadecylurea; 1,1-di-n-octadecyl-3-t-butyl-3-phenylurea; 1-p-biphenyl-1-methyl-3-noctadecyl 3 phenylurea; 1-methyl-1-n-octadecyl-3 p-biphenyl-3-o-tolylurea; m-terphenyl-tri-t-butylurea; 1,3-dimethyl-2-imidazolidinone; 1,3-diethyl-2-imidazolidinone; 1,3-dipropyl-2-imidazolidinone; 1,3-dibutyl-2-imidazolidinone; 1,3-dimethyl-3,4,5,6-tetrahydro-2-pyrimidinone; and N,N-dimethyl-N,N,-diphenylurea,

Preferred examples of malonate compounds that can be used as an internal electron donor in conjunction with diglycidylester compound include, but are not limited to: diethyl2-isopropylmalonate; diethyl2-phenylmalonate; dineopentyl 2-isopropylmalonate; diisobutyl 2-isopropylmalonate; di-n-butyl 2-isopropylmalonate; diethyl 2-dodecylmalonate; diethyl 2-t-butylmalonate; diethyl 2-(2-pentyl)malonate; diethyl 2-cyclohexylmalonate; dineopentyl 2-t-butylmalonate; dineopentyl 2-isobutylmalonate; diethyl 2-cyclohexylmethylmalonate; dimethyl 2-cyclohexylmethylmalonate; diethyl 2,2-dibenzylmalonate; diethyl 2-isobutyl-2-cyclohexylmalonate; dimethyl 2-n-butyl-2-isobutylmalonate; diethyl 2-n-butyl-2-isobutylmalonate; diethyl 2-isopropyl-2-n-butylmalonate; diethyl 2-methyl-2-isopropylmalonate; diethyl 2-isopropyl-2-isobutylmalonate; diethyl 2-methyl-2-isobutylmalonate; diethyl 2-isobutyl-2-benzylmalonate; and diethyldiisobutylmalonate.

Preferred examples of 1,3-diether compounds that can be used as an internal electron donor in conjunction with diglycidylester compound include, but are not limited to: 2-(2-ethylhexyl)1,3-dimethoxypropane; 2-isopropyl-1,3-dimethoxypropane; 2-butyl-1,3-dimethoxypropane; 2-sec-butyl-1,3-dimethoxypropane; 2-cyclohexyl-1,3-dimethoxypropane; 2-phenyl-1,3-dimethoxypropane; 2-tert-butyl-1,3-dimethoxypropane; 2-cumyl-1,3-dimethoxypropane; 2-(2-phenylethyl)-1,3-dimethoxypropane; 2,2-diethyl-1,3-diethoxypropane; 2,2-dicyclopentyl-1,3-dimethoxypropane; 2,2-dipropyl-1,3-diethoxypropane; 2,2-dibutyl-1,3-diethoxypropane; 2-methyl-2-ethyl-1,3-dimethoxypropane; 2-methyl-2-propyl-1,3-dimethoxypropane; 2-methyl-2-benzyl-1,3-dimethoxypropane; 2,2-diphenyl-1,3-dimethoxypropane; 2,2-dibenzyl-1,3-dimethoxypropane; 2-isopropyl-2-cyclopentyl-1,3-dimethoxypropane; 2,2-bis(cyclohexylmethyl)-1,3-dimethoxypropane; 2,2-diisobutyl-1,3-diethoxypropane; 2,2-diisobutyl-1,3-dibutoxypropane; 1,1-bis(methoxymethyl)-7-(3,3,3-trifluoropropyl)indene; 1,1-bis(methoxymethyl)-7-trimethyisilylindene; 1,1-bis(methoxymethyl)-7-trifluoromethylindene; 1,1-bis(methoxymethyl)-4,7-dimethyl-4,5,6,7-tetrahydroindene; 1,1-bis(methoxymethyl)-7-methylindene; 1,1-bis(methoxymethyl)-1H-benz[e]indene; 1,1-bis(methoxymethyl)-1H-2-methylbenz[e]indene; 9,9-bis(methoxymethyl)fluorene; 9,9-bis(methoxymethyl)-2,3,6,7-tetramethylfluorene; 9,9-bis(methoxymethyl)-2,3,4,5,6,7-hexafluorofluorene; 9,9-bis(methoxymethyl)-2,3-benzofluorene; 9,9-bis(methoxymethyl)-2,3,6,7-dibenzofluorene; 9,9-bis(methoxymethyl)-2,7-diisopropylfluorene; 9,9-bis(methoxymethyl)-1,8-dichlorofluorene; 9,9-bis(methoxymethyl)-2,7-dicyclopentylfluorene; 9,9-bis(methoxymethyl)-1,8-difluorofluorene; 9,9-bis(methoxymethyl)-1,2,3,4-tetrahydrofluorene; 9,9-bis(methoxymethyl)-1,2,3,4,5,6,7,8-octahydrofluorene; and 9,9-bis(methoxymethyl)-4-tert-butylfluorene.

In a preferred embodiment of the present invention, the molar ratio of the diglycidyl ester compound of Formula I versus the malonate compound is preferably between about 0.2 to about 0.6, and more preferably between about 0.25 to about 0.4. In another embodiment of the present invention, the molar ratio of malonate compound versus 1,3-diether compound is preferably between about 1.0 to about 1.8, and more preferably between about 1.2 to about 1.6.

Acceptable anhydrous magnesium dihalides forming the support of the solid Ziegler-Natta type catalyst component (a) are the magnesium dihalides in active form that are well known in the art. Such magnesium dihalides may be preactivated, may be activated in situ during titanation, or may be formed in-situ from a magnesium compound that is capable of forming magnesium dihalide when treated with a suitable halogen-containing transition metal compound, and then activated. Preferred magnesium dihalides are magnesium dichloride and magnesium dibromide. The water content of the anhydrous magnesium dihalides is generally less than about 1% by weight.

The solid Ziegler-Natta type catalyst component (a) may be made by various methods. One such method consists of co-grinding the magnesium dihalide and the internal electron donor compound until the product shows a surface area higher than 20 m²/g and thereafter reacting the ground product with the Ti compound. Other methods of preparing solid Ziegler-Natta type catalyst component (a) are disclosed in U.S. Pat. Nos. 4,220,554; 4,294,721; 4,315,835; 4,330,649; 4,439,540; 4,816,433; and 4,978,648. These methods are incorporated herein by reference.

In a typical modified solid Ziegler-Natta type catalyst component (a), the molar ratio between the magnesium dihalide and the halogenated titanium compound is between 1 and 500, the molar ratio between said halogenated titanium compound and the internal electron donor is between 0.1 and 50, and the molar ratio between said internal electron donor and the oxalic acid diamide modifier is between 0.1 and 100.

Co-catalyst component (b) is preferably selected from aluminum alkyl compounds.

Preferred aluminum alkyl compounds include, but is not limited to, aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst component (b) includes compounds containing two or more aluminum atoms linked to each other through hetero-atoms, such as:

(C₂H₅)₂Al—O—Al(C₂H₅)₂

(C₂H₅)₂Al—N(C₆H₅)—Al(C₂H)₂; and

(C₂H₅)₂Al—O—SO₂—O—Al(C₂H₅)₂.

External electron donor component (c) is preferably selected from organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters and amides, etc. In a preferred embodiment of the present invention, component (c) is an organosilicon compound containing Si—O—C and/or Si—N—C bonds, such as trimethylmethoxysilane; diphenyldimethoxysilane; cyclohexylmethyldimethoxysilane; diisopropyldimethoxysilane; dicyclopentyldimethoxysilane; isobutyltriethoxysilane; vinyltrimethoxysilane; dicyclohexyldimethoxysilane; 3-tert-Butyl-2-isobutyl-2methoxy-[1,3,2]oxazasilolidine; 3-tert-Butyl-2-cyclopentyl-2-methoxy-[1,3,2]oxazasilolidine; 2-Bicyclo[2.2.1]hept-5-en-2-yl-3-tert-butyl-2-methoxy-[1,3,2]oxazasilolidine; 3-tert-Butyl-2,2-diethoxy-[1,3,2]oxazasilolidine; 4,9-Di-tert-butyl-1,6-dioxa-4,9-diaza-5-sila-spiro[4.4]nonane; and bis(perhydroisoquinolino)dimethoxysilane.

Mixtures of organic electron donors may also be used. Alternatively, oxalic acid diamides may also be employed as an external electronic donor.

The olefin polymerization processes that may be used in accordance with the present invention are not generally limited. For example, the catalyst components (a), (b) and (c), when employed, may be added to the polymerization reactor simultaneously or sequentially. It is preferred to mix components (b) and (c) first and then contact the resultant mixture with component (a) prior to the polymerization.

The olefin monomer may be added prior to, with, or after the addition of the Ziegler-Natta type catalyst system to the polymerization reactor. It is preferred to add the olefin monomer after the addition of the Ziegler-Natta type catalyst system. The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from about 40-90° C. and the polymerization pressure is generally 1 atmosphere or higher.

The Ziegler-Natta type catalyst systems of the present invention may be pre-contacted with small quantities of olefin monomer, well known in the art as prepolymerization, in a hydrocarbon solvent at a temperature of about 60° C. or lower for a time sufficient to produce a quantity of prepolymer from about 0.5 to about 3 times the weight of the catalyst. If such a prepolymerization is done in liquid or gaseous monomer, the quantity of resultant polymer is generally up to 1000 times the catalyst weight.

The Ziegler-Natta type catalyst systems of the present invention are useful in the polymerization of olefins, including but not limited to homopolymerization and copolymerization of alpha olefins. Suitable α-olefins that may be used in a polymerization process in accordance with the present invention include olefins of the general formula CH₂=CHR, where R is H or C₁. 1o straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homopolymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The activity values (AC) are based upon grams of polymer produced per gram of solid catalyst component used.

The following analytical methods are used to characterize the polymer.

Heptane Insolubles (% HI): The weight percent (wt %) of residuals of polypropylene sample after extracted with boiling heptane for 8 hours.

Melt Flow Rate (MI): ASTM D-1238, determined at 230° C. under the load of 2.16 kg.

Tₘ: ASTM D-3417, determined by DSC (Manufacturer: TA Instrument, Inc; Model: DSC Q1000).

Determination of Isotactic Pentads Content: Place 400 mg of polymer sample into 10 mm NMR tube. 1.7 g TCE-d2 and 1.7 g o-DCB were added into the tube. ¹³C NMR spectra were acquired on a Bruker AVANCE 400 NMR (100.61 MHz, 90° pulse, 12 s delay between pulse). About 5000 transients were stored for each spectrum; mmmm pentad peak (21.09 ppm) was used as reference. The microstructure analysis was carried out as described in literature (Macromolecules, 1994, 27, 4521-4524, by V. Busico, et al.).

Molecular weight (Mn and Mw): The weight average molecular weight (Mw), number average molecular weight (Mn), and molecular weight distribution (Mw/Mn) of polymers were obtained by gel permeation chromatography on Water 2000GPCV system using Polymer Labs Plgel 10 um MIXED-B LS 300×7.5 mm columns and 1,2,4-trichlorobenzene (TCB) as mobile phase. The mobile phase was set at 0.9 ml/min, and temperature was set at 145° C. Polymer samples were heated at 150° C. for two hours. Injection volume was 200 microliters. External standard calibration of polystyrene standards was used to calculate the molecular weight.

Magnesium ethoxide (98%), anhydrous toluene (99.8%), TiCl₄ (99.9%), anhydrous n-heptane (99%), diisobutyl phthalate (99%), cyclohexyl(dimethoxy)methylsilane (C-donor, ≥99%) and triethylaluminum (93%) were all purchased from Sigma-Aldrich Co. of Milwaukee, WI, USA.

Diisopropyldimethoxysilane (P-donor) and dicyclopentyldimethoxysilane (D-donor) were purchased from Gelest, Inc. of Morrisville, PA, USA.

Unless otherwise indicated, all reactions were conducted under an inert atmosphere.

### Example 1

### (A) The Preparation of a Solid Catalyst Component

To a three-neck 250 ml flask equipped magnetic bar, which is thoroughly purged with anhydrous nitrogen, 7.5 g of magnesium ethoxide, and 70 ml of anhydrous toluene was introduced to form a suspension. 2.0 mmol of tetramethylurea, 2.0 mmol of diglycidyl-1,2-cyclohexanedicarboxylate, 7.0 mmol of diethylphenylmalonate and 5.0 mmol of 2-isopentyl-2-isopropyl-dimethoxypropane were charged and then 20 ml of TiCl4 was added. The temperature of the mixture was gradually raised to 110° C., and maintained for 2 hours with stirring. The resulting solid was precipitated and supernatant liquid was decanted. The solid was washed twice with 100 ml of anhydrous toluene at 90° C., and then 80 ml of fresh anhydrous toluene and 20 ml TiCl₄ was added to the filtered solid. Temperature of the mixture was heated to 110° C., and stirred for 2 hours. The solid was precipitated and supernatant liquid was decanted and residual solid was washed with heptane 7 times at 70° C. The final catalyst was collected and dried under vacuum to obtain a solid catalyst component (A1).

### (B) Propylene Bulk Phase Polymerization

Propylene polymerization was conducted in a bench scale 2 liter reactor per the following procedure. The reactor was first preheated to at least 100° C. with a nitrogen purge to remove residual moisture and oxygen. The reactor was thereafter cooled to room temperature. Under nitrogen, 2.5 ml of triethylaluminum (0.6M, in hexanes), 0.25 mmol of diisopropyldimethoxysilane and 7 mg of solid catalyst component (A1) prepared above were charged. After addition of hydrogen and 1.2 liter of liquefied propylene, temperature was raised to 70° C., to start polymerization. The polymerization was conducted for 1 hour at 70° C. The polymer was evaluated for melt flow rate (MFR), heptane insoluble (HI %). The activity of catalyst (AC) was also measured. The results are shown in TABLES 1 and 2.

### Example 2

A solid catalyst component (A2) was prepared in the same manner as in Example 1, except that 6.0 mmol of diethylphenylmalonate instead of 7.0 mmol diethylphenylmalonate. Propylene polymerization was carried out in the same manner as described in Example 1, except that solid catalyst component (A2) was charged instead of solid catalyst component (A1). The results are summarized in TABLE 1 & 2.

### Example 3

A solid catalyst component (A2) was prepared in the same manner as in Example 1, except that 1.5 mmol of diglycidyl-1,2-cyclohexanedicarboxylate was added. Propylene polymerization was carried out in the same manner as described in Example 1, except that solid catalyst component (A3) was charged instead of solid catalyst component (A1). The results are summarized in TABLES 1 and 2.

### Comparative Example 1

A solid catalyst component (Cl) was prepared in the same manner as in Example 1, except that 2.0 mmol of diglycidyl-1,2-cyclohexanedicarboxylate was not added. The final catalyst was collected and dried under vacuum to obtain a solid catalyst component (Cl). Propylene polymerization was carried out in the same manner as described in Example 1, except that solid catalyst component (Cl) was charged instead of solid catalyst component (A1). The results are summarized in TABLES 1 and 2.

### Comparative Example 2

A solid catalyst component (C2) was prepared in the same manner as in Example 1, except that 2.0 mmol of tetramethylurea and 2.0 mmol of diglycidyl-1,2-cyclohexanedicarboxylate were not added. The final catalyst was collected and dried under vacuum to obtain a solid catalyst component (C2). Propylene polymerization was carried out in the same manner as described in Example 1, except that solid catalyst component (C2) was charged instead of solid catalyst component (A1). The results are summarized in TABLES 1 and 2.

TABLE 1
Internal donor composition added for preparation of catalysts

| Example | Catalysts | Diglycidylester (mmol) | Internal donors (mmol) |
|---|---|---|---|
| Example 1 | A1 | Diglycidyl-2,2- | Tetramethylurea (2.0 mmol) |
| | | cyclohexane dicarboxylate | diethylphenylMalonate (7.0 mmol) |
| | | (2.0 mmol) | 2-isopentyl-2-isopropyl-dimethoxypropane |
| | | | (5.0 mmol) |
| Example 2 | A2 | Diglycidyl-2,2- | Tetramethylurea (2.0 mmol) |
| | | cyclohexane dicarboxylate | diethylphenylMalonate (6.0 mmol) |
| | | (2.0 mmol) | 2-isopentyl-2-isopropyl-dimethoxypropane |
| | | | (5.0 mmol) |
| Example 3 | A3 | Diglycidyl-2,2- | Tetramethylurea (2.0 mmol) |
| | | cyclohexane dicarboxylate | diethylphenylMalonate (7.0 mmol) |
| | | (1.5 mmol) | 2-isopentyl-2-isopropyl-dimethoxypropane |
| | | | (5.0 mmol) |
| Comparative | C1 | No | Tetramethylurea (2.0 mmol) |
| Example 1 | | | diethylphenylMalonate (7.0 mmol) |
| | | | 2-isopentyl-2-isopropyl-dimethoxypropane |
| | | | (5.0 mmol) |
| Comparative | C2 | No | diethylphenylMalonate (7.0 mmol) |
| Example 2 | | | 2-isopentyl-2-isopropyl-dimethoxypropane |
| | | | (5.0 mmol) |

TABLE 2
Bulk phase polymerization results

| Example | Catalysts | H2(psi) | MFR | Yield (g) | Hi % |
|---|---|---|---|---|---|
| Example 1 | A1 | 10 | 3.0 | 321.7 | 99.3 |
| | | 30 | 20.4 | 342.1 | 98.6 |
| | | 60 | 75.5 | 326.5 | 98.1 |
| Example 2 | A2 | 10 | 4.0 | 294.3 | 99.2 |
| | | 20 | 11.8 | 275.1 | 98.8 |
| | | 30 | 23.0 | 240.4 | 98.6 |
| | | 60 | 80.4 | 277.9 | 98.0 |
| Example 3 | A3 | 10 | 8.1 | 302.0 | 99.1 |
| | | 20 | 15.6 | 288.5 | 98.8 |
| | | 30 | 21.6 | 244.6 | 98.5 |
| | | 40 | 31.6 | 259.2 | 98.6 |
| | | 60 | 81.2 | 283.0 | 98.0 |
| Comparative | C1 | 10 | 6.2 | 314.1 | 98.3 |
| Example 1 | | 30 | 21.8 | 320.5 | 98.1 |
| | | 60 | 73.3 | 280.3 | 97.3 |
| Comparative | C2 | 10 | 7.53 | 305.1 | 98.6 |
| Example 2 | | 30 | 19.8 | 280.3 | 98.1 |

As shown from the above results, the catalyst components (A1, A2) according to present invention employing diglycidyl-1,2-cyclohexyldicarboxylate compounds in combination with internal electron donors of tetramethylurea, diethylphenylmalonate, and 2-isopentyl-2-isopropyl-dimethoxypropane produce polypropylene with an isotacticity much higher than the comparative catalyst components (C1, C2) that does not contain diglycidyl-1,2-cyclohexyldicarboxylate in its solid catalyst composition.

For example, for a given loading of 7.0 mmol of diethylphenylmalonate and 5.0 mmol of 2-isopentyl-2-isopropyl-dimethoxypropane, Catalyst A1 containing diglycidyl-1,2-cyclohexyldicarboxylate in its catalyst composition produced PP having 98.6% HI at MFR=20.4 (Example 1), 98.5% HI at MFR=21.6 which is higher than PP having 98.1% HI produced by comparative catalyst components (C1, C2) that does not contain diglycidyl-1,2-cyclohexyldicarboxylate element in its solid catalyst composition.

Further, the catalyst component (A2) according to present invention employing diglycidyl-1,2-cyclohexyldicarboxylate with less amount malonate (6.0 mmol) and 1,3-diether, produced PP having 98.6% HI at MFR=21.6 (Example 2), which is higher than PP having 98.1% HI produced by comparative catalyst components (C1, C2) that does not contain diglycidyl-1,2-cyclohexyldicarboxylate element in its solid catalyst composition.

Further, the catalyst components (A1, A2, A3) according to present invention employing diglycidyl-1,2-cyclohexyldicarboxylate compounds in combination with internal donors of tetramethylurea, diethylphenylmalonate, and 2-isopentyl-2-isopropyl-dimethoxypropane produced polypropylene of high MFR=75.5-81.2 with high % HI (98.0-98.1%).

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A solid catalyst component for the polymerization or co-polymerization of alpha-olefins comprising: titanium, magnesium, halogen, one or more internal electron donors, and one or more diglycidylester compounds selected from the compound represented by Formula I: 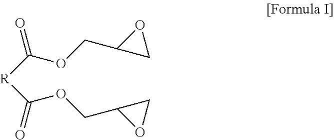
wherein R is a hydrocarbon having 1 to 20 carbon atoms.

2. The solid catalyst component of claim 1, wherein at least one of the internal electron donors is selected from a urea compound.

3. The solid catalyst component of claim 1, wherein at least one of the internal donors is selected from a malonate compound.

4. The solid catalyst component of claim 1, wherein at least one of the internal donors is selected from a 1,3-diether compound.

5. The solid catalyst component of claim 1, wherein the one or more internal donors comprises a urea compound, a malonate compound, and a 1,3-diether compound.

6. The solid catalyst component of claim 1, wherein the one or more diglycidylester compounds comprises diglycidyl-2,2-cyclohexane dicarboxylate.

7. The solid catalyst component of claim 1, wherein the diglycidylester compounds are selected from diglycidylphthalate, diglycidyl-1,2-cyclohexanedicarboxylate, diglycidyl-1,2-cyclopentanedicarboxylate, diglycidyl-1,2-cyclobutanedicarboxylate, diglycidyl-2,3-isopropylsuccinate, diglycidylsuccinate, diglycidylmalonate, diglycidylglutarate, bis(2,3-epoxypropyl) adipate, or their derivatives.

8. The solid catalyst component of claim 3, wherein the malonate compound comprises diethylphenylmalonate

9. The solid catalyst component of claim 3, wherein the malonate compound is selected from diethyl-2-isopropylmalonate, diethyl2-phenylmalonate, dineopentyl 2-isopropylmalonate, diisobutyl 2-isopropylmalonate, di-n-butyl 2-isopropylmalonate, diethyl 2-dodecylmalonate, diethyl 2-t-butylmalonate, diethyl 2-(2-pentyl)malonate, diethyl 2-cyclohexylmalonate, dineopentyl 2-t-butylmalonate, dineopentyl 2-isobutylmalonate, diethyl 2-cyclohexylmethylmalonate, dimethyl 2-cyclohexylmethylmalonate, diethyl 2,2-dibenzylmalonate, diethyl 2-isobutyl-2-cyclohexylmalonate, dimethyl 2-n-butyl-2-isobutylmalonate, diethyl 2-n-butyl-2-isobutylmalonate, diethyl 2-isopropyl-2-n-butylmalonate, diethyl 2-methyl-2-isopropylmalonate, diethyl 2-isopropyl-2-isobutylmalonate, diethyl 2-methyl-2-isobutylmalonate, diethyl 2-isobutyl-2-benzylmalonate, or diethyldiisobutylmalonate.

10. The solid catalyst component of claim 4, wherein the 1,3-diether compound comprises 2-isopentyl-2-isopropyl-dimethoxypropane.

11. The solid catalyst component of claim 4, wherein the 1,3-diether compound is selected from 2-(2-ethylhexyl)-1,3-dimethoxypropane; 2-isopropyl-1,3-dimethoxypropane; 2-butyl-1,3-dimethoxypropane; 2-sec-butyl-1,3-dimethoxypropane; 2-cyclohexyl-1,3-dimethoxypropane; 2-phenyl-1,3-diethoxypropane; 2-cumyl-1,3-diethoxypropane; 2-(2-cyclohexylethyl)-1,3-dimethoxypropane; 2,2-fluorophenyl)-1,3-dimethoxypropane; 2-(1-decahydronaphthyl)-1,3-dimethoxypropane; 2,2-dicyclohexyl-1,3-dimethoxypropane; 2-isopentyl-2-isopropyl-1,3-dimethoxypropane; 2,2-diisobutyl-1,3-dimethoxypropane; 2-isopropyl 2-isopentyl-1,3-dimethoxypropane; 2,2-bis(cyclohexylmethyl)-1,3-dimethoxypropane; 9,9-bis(methoxymethyl)fluorene; 9,9-bis(methoxymethyl)-2,3,6,7-tetramethylfluorene; 9,9-bis(methoxymethyl)-2,3,4,5,6,7-hexafluorofluorene; 9,9-bis(methoxymethyl)-2,7-diisopropylfluorene; 9,9-bis(methoxymethyl)-1,8-dichlorofluorene; 9,9-bis(methoxymethyl)-2,7-dicyclopentylfluorene; 9,9-bis(methoxymethyl)-1,8-difluorofluorene; 9,9-bis(methoxymethyl)-1,2,3,4-tetrahydrofluorene; 9,9-bis(methoxymethyl)-1,2,3,4,5,6,7,8-octahydrofluorene; or 9,9-bis(methoxymethyl)-4-tert-butylfluorene.

12. The solid catalyst component of claim 2, wherein the urea compound comprises tetramethylurea.

13. The solid catalyst component of claim 2, wherein urea is selected from N,N,N′,N′-tetramethylurea; N,N,N′,N′-tetraethylurea; N,N,N′,N′-tetrapropylurea; N,N,N′,N′-tetrabutylurea; N,N,N′,N′-tetrapentylurea; N,N,N′,N′-tetrahexylurea; N,N,N′,N′-tetra(cyclopropyl)urea; N,N,N′,N′-tetra(cyclohexyl)urea; N,N,N′,N′-tetraphenylurea; bis(butylene)urea; bis(pentylene)urea; N,N′-dimethylethyleneurea; N,N′-dimethylpropyleneurea: N,N′-dimethyl(2-(methylaza)propylene)urea; N,N′-dimethyl(3-(methylaza)pentylene)urea; n-amyltriphenylurea; n-hexyltriphenylurea; n-octyltriphenylurea; n-decyltriphenylurea; n-octadecyltriphenylurea; n-butyltritolylurea; n-butyltrinaphthylurea; n-hexyltrimethylurea; n-hexyltriethylurea; noctyltrimethylurea; dihexyldimethylurea; dihexyldiethylurea; trihexylmethylurea; tetrahexylurea: n-butyltricyclohexylurea; t-butyltriphenylurea; 1,1-bis(p-biphenyl)-3-methyl-3-n-octadecylurea; 1,1-di-n-octadecyl-3-t-butyl-3-phenylurea; 1-p-biphenyl-1-methyl-3-noctadecyl 3 phenylurea; 1-methyl-1-n-octadecyl-3 p-biphenyl-3-o-tolylurea; m-terphenyl-tri-t-butylurea, 1,3-dimethyl-2-imidazolidinone; 1,3-diethyl-2-imidazolidinone; 1,3-dipropyl-2-imidazolidinone; 1,3-dibutyl-2-imidazolidinone; 1,3-dimethyl-3,4,5,6-tetrahydro-2-pyrimidinone; or N,N-dimethyl-N,N,-diphenylurea.

14. A catalyst system for the polymerization or co-polymerization of alpha-olefins comprising:
a) the solid catalyst component of claim 1; and
b) a co-catalyst component comprising an organoaluminum compound.

15. The catalyst system of claim 14, further comprising one or more external electron donor components.
